(19) United States
(12) Patent Application Publication
(10) Pub. No.: US 2003/0084231 A1
(43) Pub. Date: May 1, 2003

(54) Nonvolatile semiconductor storage device with interface functions

(75) Inventor: Yoshimasa Yoshimura, Tokyo (JP)

Correspondence Address: MCDERMOTT, WILL & EMERY, 600 13th Street, N.W., Washington, DC, 20005-3096, US

(73) Assignee: Mitsubishi Denki Kabushiki Kaisha

(21) Appl. No.: 10/137,330

(22) Filed: May 3, 2002

(30) Foreign Application Priority Data
Nov. 1, 2001 (JP) 2001-336609

(51) Int. Cl. G06F 12/00

(52) U.S. Cl. 711/103; 714/6

(57) ABSTRACT

A nonvolatile semiconductor storage device directly connected to CPU buses and general-purpose buses is provided. The device has a nonvolatile memory cell array with block units including a plurality of sectors. Each sector stores user data by being specified each address. The device has a sequencer which judges whether predetermined types of the access operation is carried out or not. The judgment is achieved based on: a command register which sets a command to specify type of access operation to the array; an address register which sets the access address; a count register which sets a number of the sectors to be accessed; a status register which holds status indicating whether processing according to the command set to the command register; status; and the command. The sequencer accesses to the array based on the address set and the number of sectors when the access operation is carried out.

### BACKGROUND OF THE INVENTION

1. Field of the Invention

The present invention relates to a nonvolatile semiconductor storage device for storage application, and more specifically, the invention relates to a flash memory for storage application that can read, write, and erase data.

2. Description of the Background Art

Nonvolatile semiconductor storage devices called flash memories fall into two broad general categories. That is, flash memories suited for storing program codes such as DINOR type and NOR type, and those suited for storage application such as AND type and NAND type. The former DINOR type and NOR type flash memories provide superb random access capabilities. Since data can be written byte by byte, these memories are used for storing program codes, configuration parameters, etc. For example, in the case the former flash memory stores the program codes, it can randomly read the program codes.

The latter flash memories for storage application cannot write data byte by byte but write the data in units called blocks. To be more specific, the flash memories for storage access data, i.e. read, write, and erase data, block by block. The latter flash memories write data faster than the former ones and are suited for increased capacity.

The flash memories for storage application are generally formed by multiplexing address buses and data buses. This is because the flash memories for storage application do not read the data randomly unlike the former flash memories and furthermore, the number of pins must be reduced. This kind of flash memories for storage application has been already commercialized, such as M5M29F25611VP, by Mitsubishi Electric Corp.

Because, in the flash memories for storage application, the address buses and the data buses are multiplexed, the specific interfaces (e.g. signal, protocol, etc.) must be needed. Consequently, in order to incorporate such flash memories into apparatuses or devices, it is unable to be directly connected to CPU buses or general-purpose buses, and an interface circuit designed in conformity to the system must be prepared. This requires extra time and cost. In addition, in packaging, an area for installing the interface circuit must be secured, which is disadvantageous in light of high-density packaging.

### SUMMARY OF THE INVENTION

It is an object of the present invention to provide flash memory for storage that can be directly connected to CPU buses and general-purpose buses.

A nonvolatile semiconductor storage device includes a memory cell array of nonvolatile type with block units including a plurality of sectors, each of the plurality of sectors storing user data by being specified each address; a command register which sets a command to specify type of access operation to the memory cell array; an address register which sets the each address to be accessed; a count register which sets a number of the plurality of sectors to be accessed; and a status register which holds status indicating whether processing according to the command set to the command register is carried out or not. The device further includes a sequencer being activated in response to setting of the command to the command register. The sequencer judges whether the type of the access operation is carried out or not based on the command set to the command register and the status held in the status register. In the case the type of the access operation is carried out, the sequencer accessing to the memory cell array based on the each address set to the address register and the number of the sectors set to the count register.

This kind of nonvolatile semiconductor storage device is, for example, the flash memory for storage application and is able to be easily incorporated into the instrument without causing additional technical inconvenience or cost. Since no interface circuit is required, it becomes advantageous in light of high-density packaging. Thus, a semiconductor storage that can be controllable on the register base can be obtained, which can be accessed by the interface same as the known SRAM. Consequently, direct connection to CPU buses and general-purpose buses is enabled.

The nonvolatile semiconductor storage device further includes an error correcting circuit which generates check data to correct errors generated in the user data; and a buffer which stores the user data in units of the plurality of sectors subject to the access operation to the memory cell array and which stores the check data generated by the error correcting circuit. In the case the access operation is data writing, the sequencer may write into the memory cell array the user data subject to the access operation stored in the buffer and the check data generated in the error correcting circuit. Thus, errors can be reduced at the time of write operation of the user data.

The nonvolatile semiconductor storage device further includes an error correcting circuit which generates check data to correct errors generated in the user data; and a buffer which stores the user data in units of the plurality of sectors subject to the access operation to the memory cell array and which stores the check data generated by the error correcting circuit. In the case the access operation is data reading, the error correcting circuit may detect to correct the errors based on the user data read and the check data generated in advance and stored in the memory cell array. Since errors can be detected and corrected based on the user data read out and the check data at the time of reading, higher reliability is achieved for the user data.

Each of the plurality of sectors has a user data area used to store the user data and the check data, and a control data area used to store management data to manage the each of the plurality of sectors. The control data area may be used to store free data whose errors are uncorrected by the error correcting circuit, and to store the check data of a first management data whose errors are corrected and a second management data generated by the error correcting circuit. Thus, it is possible to set the data with the error corrected and the data with error not corrected from the host side. In addition, the free data is not susceptible to other existing data even when the contents are changed. Consequently, it is possible to rewrite the free data only, and by this, it is possible to utilize it as a flag for indicating the characteristics of other data.

The nonvolatile semiconductor storage device further includes a control register which specifies an area subject to the access operation between the user data area and the control data area. The sequencer may specify the area of a corresponding sector to be accessed based on the control register. The sequencer is allowed to specify the area of the sector to be accessed based on the control register. Accordingly, the area to be accessed is able to be specified from the host side.

### BRIEF DESCRIPTION OF THE DRAWINGS

These and other object and features of the present invention will become clear from the following description taken in conjunction with the preferred embodiments thereof with reference to the accompanying drawings, in which:

FIG. 1 is a block diagram showing a configuration of a storage system according to the present invention;

FIG. 2 is a diagram of an exemplary register map;

FIG. 3 is a diagram of an exemplary status register;

FIG. 4 is a diagram of sector data structure of flash memory cell array;

FIG. 5 is a diagram of data configuration of a control register;

FIG. 6 is a flow chart of data reading operation of the host and the nonvolatile semiconductor storage device and

FIG. 7 is a flow chart of data write operation of the host and the nonvolatile semiconductor storage.

### DETAILED DESCRIPTION OF THE PREFERRED EMBODIMENTS

Referring to the attached drawings, preferred embodiments of the present invention will be described.

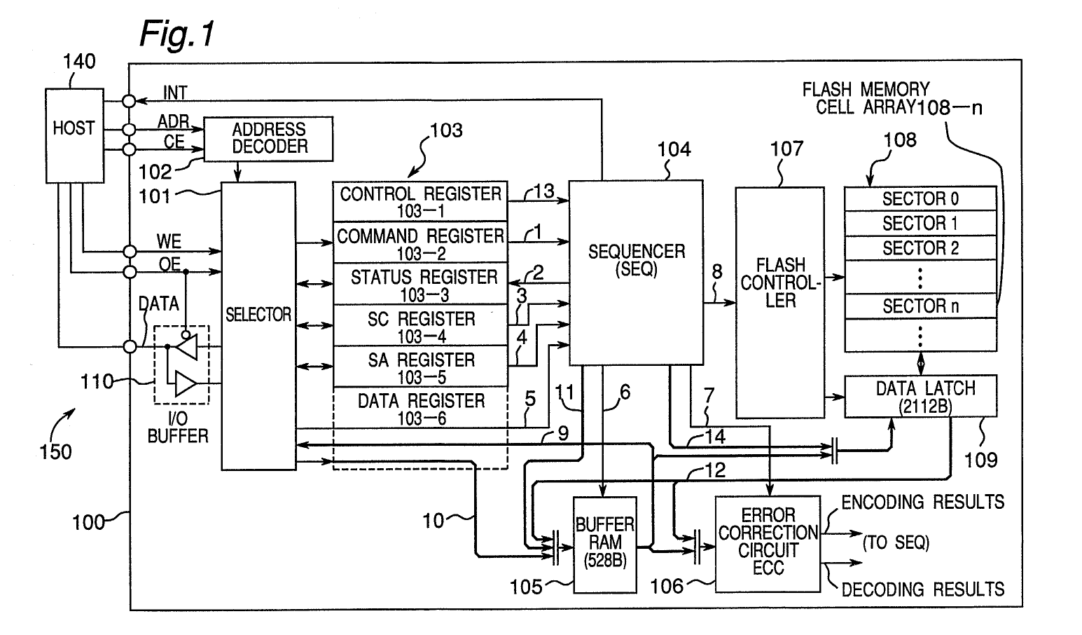

FIG. 1 is a block diagram showing a configuration of storage system 150 according to the present invention. Storage system 150 is utilized in personal computers (PCs), hand-held terminals, and other instruments. Storage system 150 includes host 140 and nonvolatile semiconductor storage device 100 (hereinafter referred to as “nonvolatile storage”) according to the present embodiment. Host 140 is a central processing unit (CPU) which controls the above-mentioned instrument. Nonvolatile storage 100 is a flash memory for data storage application which can be accessed via an interface same as known static random access memory (SRAM) and which can be controlled by means of registers. Nonvolatile storage 100 is a flash memory with high writing speed and suited for increased capacity. Nonvolatile storage 100 is, for example, an ATA card. Card type nonvolatile storage 100 is used by digital instruments as an external storage media for recording digital information such as character information, image information, music information, and so on.

In storage system 150, host 140 and nonvolatile storage 100 are connected with a plurality of buses. The plurality of buses are 3-bit address buses ADR which specify an address, chip-enable CE which enables nonvolatile storage 100, write-enable WE which enables writing, control signal bus(es) which transmits each signal of output enable OE which enables outputs, data bus(es) DATA which transmits 8-bit data in bi-directions, and interruption signal bus which outputs interruption signals INT. Host 140 and nonvolatile storage 100 transmits and receives data and control signals via these buses. Note that these buses are known as conventional CPU buses and general-purpose buses. That is, nonvolatile storage 100 described in the present embodiment can be directly connected to the conventional CPU buses and general-purpose buses.

The configuration of nonvolatile storage 100 will be described as follows with roles of each signal transmitted via a plurality of buses. On outside of nonvolatile storage 100, pins (terminals) are provided so as to secure connections with a plurality of buses (hereinafter called the “external buses”). The number of terminals are as many as the number of external buses. In the figure, six terminals are provided.

Next discussion will be made on the configuration inside nonvolatile storage 100. nonvolatile storage 100 includes selector 101, address decoder 102, register group 103, sequencer (SEQ) 104, buffer RAM 105, error correction circuit (ECC) 106, flash controller 107, flash memory cell array 108, data latch 109, and I/O buffer 110. Selector 101 is a circuit which selects passing signals. That is, selector 101 selects and transmits DATA, WE, OE signals from the external buses to register group 103, or DATA signal from register group 103 to external buses. Selector 101 selects the address signal from address decoder 102 and transmits to register group 103. Address decoder 102 selects one or more registers subject to reading and writing according to the ADR and CE signals received from host 140 and specifies each address of the registers.

Register group 103 consists of control register 103-1, command register 103-2, status register 103-3, sector count register (SC register) 103-4, sector address register (SA register) 104-5, and data register 103-6. The description will be made on each register as follows. First of all, in command register 103-2, commands from host 140 are written, which specifies an access operation type such as read, write, erase, and so on. To status register 103-3, conditions (i.e. status) of command processing are written. To SC register 103-4, the number of sectors for processing commands is set. To SA register 103-5, a sector address of the sector for processing command is set. Data register 103-6 is virtually provided as a register and with no entity. An access to data register 103-6 means an access to buffer RAM 105. Host 140 can access the data on buffer RAM 105 sequentially through data register 103-6.

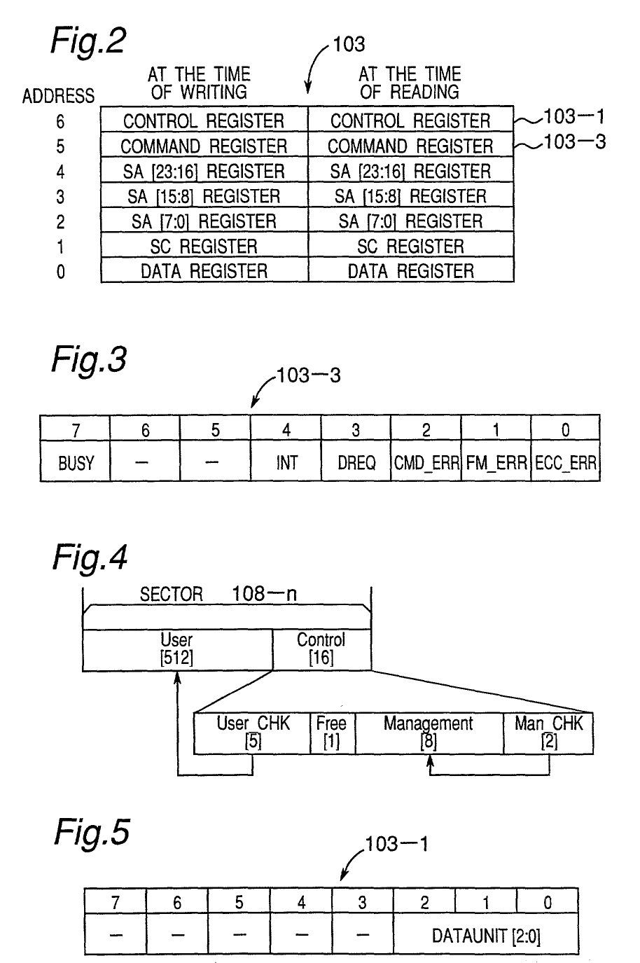

FIG. 2 shows an exemplary register map. Each register is shown in one byte, that is, as 8 bits. Register group 103 differs in its configuration when data is written and when data is read. Specifically, address 5 is used as command register 103-2 when data is written, and status register 103-3 when data is read. The reason is that command register 103-2 is written only from the host, and status register 103-3 is read only from the host. As SA register 103-5, 3 addresses are assigned in order to support sector address space up to 24 bits. Note that address buses ADR (FIG. 1) are 3 bit buses and not 24 bit buses. This is because, in the present invention, a so-called indirect access system is used, and 3 bits are sufficient for the external address buses ADR (FIG. 1) so as to identify the register.

FIG. 3 shows an example of status register 103-3. In status register 103-3, “BUSY” of the seventh bit becomes “1” during command processing, and indicates to host 140 (FIG. 1) whether the command is presently being processed or not. “INT” of the fourth bit shows an interruption and represents the level same as INT pin, which is an external terminal of nonvolatile storage 100 (FIG. 1). Note that the INT signal is cleared when host 140 (FIG. 1) reads status register 103-3. “DREQ” of the third bit shows a data request. When “DREQ” is “1,” host 140 (FIG. 1) accesses data register 103-6 (FIG. 1, FIG. 2) to read or write the contents of buffer RAM 105 (FIG. 1). “CMD_ERR” of the second bit is an error flag that is set to “1” when, for example, a command code written in command register 103-2 (FIG. 1, FIG. 2) is invalid or a value set to SC register 103-4 (FIG. 1) or SA register 103-5 (FIG. 1) is invalid. “FM_ERR” of the first bit is an error flag that is set to “1” when a write error or an erase error occurs in flash memory cell array 108 (FIG. 1). Lastly, “ECC_ERR” of the 0th bit is an error flag that indicates whether a bit error occurs or not during reading.

Referring again to FIG. 1, sequencer 104 outputs control signals 6, 7, 8 based on the command received from host 140 and controls buffer RAM 105, error correction circuit 106, and flash controller 107 to carriy out data transferring processing, ECC processing, and processing for flash memory cell array 108, respectively. Referring again to the above-mentioned example, every time host 140 accesses data register 103-6 by one byte, sequencer 104 receives control signal 5 representing a read pulse. Sequencer 104 increments the address of buffer RAM 105, which is achieved by control signal 6. This example shows the case when data is read, however in the case data is written, every time host 140 accesses data register 103-6 by one byte, sequencer 104 receives control signal 5 representing a write pulse. When data is written and/or read, sequencer 104 receives encoded data with error correcting codes added and/or decoded data which has been corrected errors by error correction circuit 106 later discussed.

Buffer RAM 105 is a random access memory (RAM) which temporarily stores data read out from flash memory cell array 108 or data to be written to flash memory cell array 108. Error correction circuit 106 corrects errors based on the error correction code for the data read out from flash memory cell array 108. The decoded data with errors corrected is transmitted to sequencer 104. Error correction circuit 106 adds error correction codes to data to be written in flash memory cell array 108. The encoded data with error correction codes added is transmitted to sequencer 104. Flash controller 107 controls accesses to flash memory cell array 108 pursuant to the control signal from sequencer 104.

Flash memory cell array 108 is an array of nonvolatile memory cells, each of which stores data. Flash memory cell array 108 is divided into units of specified size called blocks. Conventional flash memories for storage application are accessed block by block, however, the nonvolatile storage 100 according to present invention is accessed by data unit called sector, which is different from the block.

FIG. 4 shows sector data structure of flash memory cell array 108 (FIG. 1). Host 140 (FIG. 1) can access the data, sector by sector, shown in FIG. 4 regardless of physical block size of the flash memory cell array. Sector 108-n consists of 512-byte user data (User) and 16-byte control data (Control). Sector size of the user data “User” is the same as that of the general block device such as hard disk drive (HDD). The control data Control consists of an error correction check byte “User_CHK” (5 bytes) relevant to the user data, a free data “Free” (1 byte) which is not subject to the error correction by the error correcting circuit later discussed, a management data “Management” (8 bytes) for storing the sector control information, and an error correction check byte code word “Man_CHK” (2 bytes) for the management data “Management”. The data size is given just for an example, and may be of any other sizes.

Note that, because the free data is not subject to the error correction by the error correcting circuit, existing other data are not susceptible to the free data if contents of the free data are changed. Consequently, only the free data can be rewritten, and thus, it can be used for a flag that shows characteristics of the existing other data. More specifically, in a general flash memory, data must be rewritten after existent data is erased. However, from bit “1” to “0”, overwriting is possible without erasing the data. By such overwriting process, the free data may be used as a flag. For example, when a certain sector data is updated (i.e. moved) to another sector, the free data can be used for the flag for indicating that the original sector data is invalid.

It is noted that when error correction is carried out on the free data, the check byte is influenced by the rewriting of the free data, and the pattern (pattern from “0” to “1”) in which rewriting is disabled unless the data is erased, occurs. In addition, the free data “Free” is not subject to error correction in the error correcting circuit, but other error correction processing, for example, the majority of bits method may be adopted. Assuming that a value 0 or 1 is represented by the free data of 1 byte, the majority of bits method is used to determine whether the free data indicates 0 or 1 based on larger numbers of 0 or 1 in the 1 byte, i.e., 8 bits of the free data. Originally, all the bits should be 0 or 1, but even when a bit acquires an opposite value because an error occurs, the error can be corrected by such error correction processing.

Data latch 109 of FIG. 1 latches data read from flash memory cell array 108 and data to be written in flash memory cell array 108 according to the control from flash controller 107. I/O buffer 110 temporarily stores data entered from host 140 or data outputted to host 140.

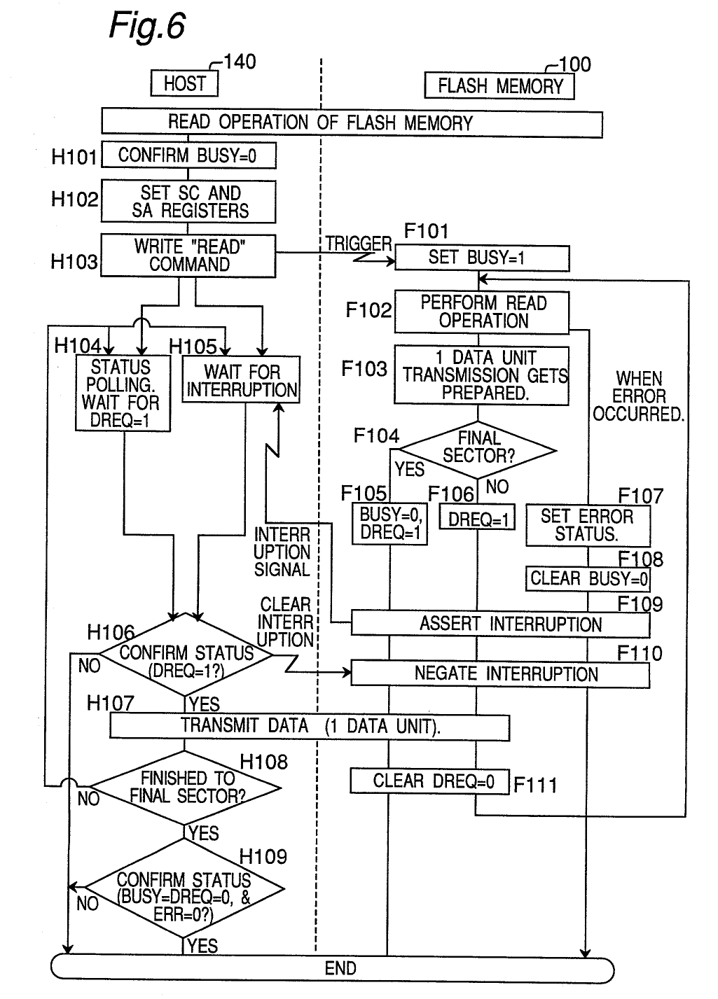

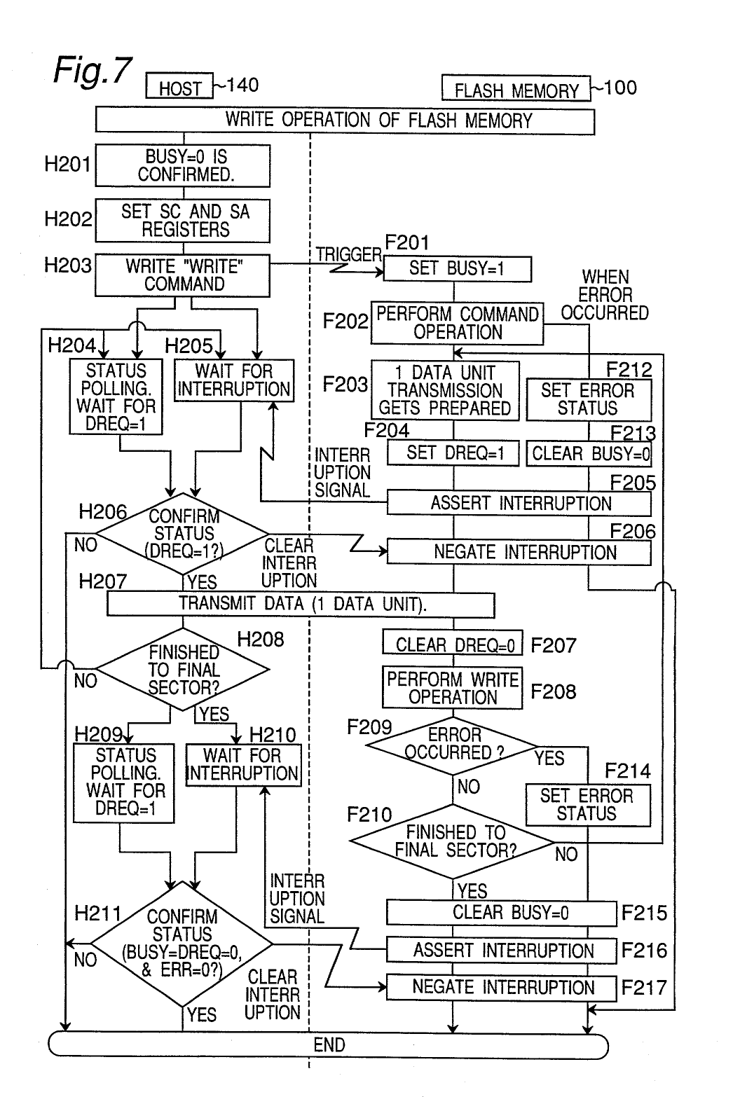

Next, the data flow will be discussed. The specific configuration of each register and more detailed description on the operation will be discussed later referring to FIGS. 6 and 7. First of all, for example, consider the case in which 16 sectors (=10 h) from sector addresses 30 h to 3 Fh are read. Host 140 sets 30 h to SA register 103-5 and further sets 10 h (=16 sectors) to SC register 103-4. Host 140 writes the read command in command register 103-2. Then, command signal 1 indicating the read command is entered in sequencer 104 and sequencer 104 is activated. Sequencer 104 outputs control signal 8 to flash controller 107. Based on control signal 8, flash controller 107 reads the data of the address specified by flash memory cell array 108 to data latch 109. Thereafter, data latch 109 transmits the data to buffer RAM 105 and error correction circuit 106 via data bus 12. Error correction circuit 106 decodes the received data. Upon completion of decoding processing, sequencer 104 writes the correct data to buffer RAM 105 via data bus 11 if any error exists according to the decoded results. When preparation of the data in buffer RAM105 is completed, host 140 sequentially reads the data from the buffer RAM via data register 103-6.

Next, data writing flow will be discussed. Host 140 sequentially writes the data into buffer RAM 105. Thereafter, host 140 writes the write command to command register 103-2. Command signal 1 indicating the write command is entered into sequencer 104 and sequencer 104 is activated. Sequencer 104 sends the data subject to be written, from buffer RAM 105 to error correction circuit 106 and to data latch 109. Error correction circuit 106 carries out encoding processing for error correction. Upon completion of encoding processing, sequencer 104 writes a check byte into data latch 109 via data bus 14 according to the encoded results. This process is repeated for each sector. When data latch 109 is filled (that is, when the data amount fills the physical block size), flash controller 107 executes program procedure. “Program procedure” means a series of control processing necessary for writing data to the flash memory, that is, for programming.

Because the control data “Control” contained in each sector (FIG. 4) is necessary for controlling each sector, it is not always necessary for host 140 (FIG. 1). Consequently, it is desirable to select the data to be accessed as required. In the present embodiment, the data to be accessed can be selected by the use of the control register.

FIG. 5 shows data structure of control register 103-1. In accordance with the data set to “DATAUNIT” of the 0th to 2nd bits of control register 103-1, the data subject to be accessed from host 140 (FIG. 1) can be selected.

For example, when DATAUNIT of control register 103-1 is 0, only the user data “User” (FIG. 4) of the sector is accessed from host 140 (FIG. 1). In such event, error correction processing automatically takes place in nonvolatile storage 100 (FIG. 1). That is, in the case the host 140 sends the read command, error correction is carried out. In the case the host 140 sends the write command, the check byte “User_CHK” (FIG. 4) is stored in flash memory cell array 108 (FIG. 1) in addition to the user data “User” (FIG. 4).

When DATAUNIT of control register 103-1 is 1, the user data “User” shown in FIG. 4, free data “Free”, and management data “Management” (total of 521 bytes) are accessed. In this case, errors are automatically corrected in nonvolatile storage 100 (FIG. 1). That is, in the case the host 140 sends the write command, errors of user data “User” and management data “Management” are corrected, and in the case the host 140 sends the write command, the check byte encoded word “User_CHK”, “Man_CHK” are stored in flash memory cell array 108 (FIG. 1).

When DATAUNIT of control register 103-1 is 2, the free data “Free” and management data “Management” (total of 9 bytes) shown in FIG. 4 are accessed. Even in this case, errors are automatically corrected in nonvolatile storage 100 (FIG. 1).

That is, in the case the host 140 sends the read command, errors of management data “Management” is corrected. In the case the host 140 sends the write command, check byte “Man_CHK” is stored in flash memory cell array 108 (FIG. 1) in addition to the free data “Free” and management data “Management”.

When DATAUNIT of control register 103-1 is 3, only free data “Free” (FIG. 4) is accessed. When DATAUNIT is 4, all the data of 528 bytes are accessed. In such event, the check byte area (User_CHK, Man_CHK) is also handled as data and no error correction processing is carried out. When DATAUNIT is 5, only the control data “Control” (FIG. 4) is accessed. In such event, the check byte area (User_CHK, Man_CHK) is also handled as data area and no error correction processing is carried out. The combination of the values of DATAUNIT with the data subject to be accessed described above is an example, and any other combinations may be acceptable.

Referring now to FIGS. 6 and 7, data reading operation and data writing operation including transfer of signals between host 140 (FIG. 1) and nonvolatile storage 100 (FIG. 1) will be described. In the following description, operations of host 140 (FIG. 1) are shown as “Step Hxxx” and operations of nonvolatile storage 100 (FIG. 1) are shown as “Step Fxxx.” Nonvolatile storage 100 is referred to as flash memory 100.

FIG. 6 is a flow chart that shows operations of host 140 and nonvolatile storage 100 when data is read. First of all, host 140 reads status register 103-3 (FIG. 1, FIG. 3) of flash memory 100 and confirms that the BUSY bit (FIG. 3) is 0 (Step H101). Then, host 140 sets the number of sectors to be accessed and the sector addresses to SC register 103-4 and SA register 103-5 (FIG. 1) (Step H102). Note that if the BUSY bit is 1, flash memory 100 does not receive the command. Then, to command register 103-2 (FIG. 1), host 140 writes the read command (Step H103). As described above, sequencer 104 (FIG. 1) is activated in response to writing of the read command. Thereafter, host 140 waits until the DREQ bit of status register 103-3 (FIG. 3) becomes 1 (Step H104). It is noted that host 140 may confirm changes of the status by polling status (Step H104) or may wait for the interruption signal from flash memory 100 (Step H105).

When the read command is written at Step H103, flash memory 100 sets the BUSY bit of status register 103-3 (FIG. 3) to 1 (Step F101). The data of the specified address is transferred from flash memory cell array 108 (FIG. 1) to buffer RAM 105 (FIG. 1) via one or more internal buses.

In the case an invalid command code, invalid values of SC register and SA register value are set, or in the case errors unable to correct occur, the flash memory 100 carries out processing for dealing errors. That is, flash memory 100 sets the error flag of status register 103-3 (FIG. 3) (Step F107), clears BUSY to 0 (Step F108), and asserts an interruption signal INT (Step F109). When host 140 reads the status register (Step H106), the interruption signal INT is negated (Step F110).

When the data is prepared in buffer RAM 105 (FIG. 1) with no error (Step F103), the process is branched according to whether the sector is final one, which is calculated by the sector number to be transferred and set to the SC register or not (Step F104). That is, when it is not the final sector (in the case of “No” in Step F104), flash memory 100 sets DREQ of status register 103-3 (FIG. 3) to 1 (Step F106), and asserts interruption signal INT (Step F109). When host 140 reads the status register (Step H106), the interruption signal is negated (Step F110). Since host 140 confirms DREQ=1 at this time, host 140 then reads the data register and reads out the sector data (Step H107). The data size at this time is the value set to DATAUNIT (FIG. 5) of the control register. When the data transfer for 1 sector is completed, DREQ is cleared to zero (Step F111), and processing from Step F102 is repeated. Since transfer of the final sector is not completed in the processing of host 140, host processing returns from Step H108 to Step H104 or H105.

Now, processing of the final sector will be described. Host 140 clears BUSY of status register 103-3 (FIG. 3) of flash memory 100 to zero and further, sets DREQ=1 (Step F105), and asserts interruption signal INT (Step F109). The interruption signal is negated (Step F110) when host 140 reads status register 103-3 (Step H106). Since host 140 confirms DREQ=1, the host reads data register 103-6 and reads out the sector data of buffer RAM 105 (FIG. 1) (Step H107). Note that the data size at this time is a value set in the DATAUNIT (FIG. 5) of the control register. When data transfer up to the final sector is completed, DREQ is cleared to 0 (Step F111) and processing of the read command is completed. Since the transfer of the final sector is finished on host 140 side, host 140 confirms the status (Step H109) and ends the processing.

FIG. 7 is a flow chart that shows operations of host 140 and nonvolatile storage 100 when data is written. First of all, host 140 reads status register 103-3 (FIGS. 1 and 3) of flash memory 100 and confirms that BUSY bit (FIG. 3) is 0 (Step H201). Then, host 140 sets the number of sectors to be accessed and the sector address to SC register 103-4 and SA register 103-5 (FIG. 1) (Step H202). Note that if BUSY bit is 1, flash memory 100 does not accept the command. Then, the host writes the write command to command register 103-2 (FIG. 1) (Step H203). Similarly as described above, sequencer 104 (FIG. 1) is activated in response to writing of the write command. Host 140 waits until the DREQ bit of status register 103-3 (FIG. 3) becomes 1 (Step H204). It is noted that host 140 may confirm changes of the status by polling status (Step H204) or may wait for the interruption signal from flash memory 100 (Step H205).

Flash memory 100 sets BUSY bit of status register 103-3 (FIG. 3) to 1 (Step F201) when the write command is written in step H103. Flash memory 100 transfers the data of the designated address from flash memory cell array 108 (FIG. 1) to buffer RAM 105 (FIG. 1) via the internal buses. Then, flash memory 100 checks parameters (Step F202).

In the case an invalid command code, or invalid values of SC register or SA register are set, flash memory 100 carries out processing for dealing errors. That is, flash memory 100 sets the error flag of status register 103-3 (FIG. 3) (Step F212), clears BUSY to 0 (Step F213), and asserts an interruption signal INT (Step F205). The interruption signal INT is negated (Step F206) when host 140 reads the status register (Step H206).

When buffer RAM 105 (FIG. 1) is initialized with no error and completes preparation for receiving data (Step F203), flash memory 100 sets DREQ of status register 103-3 (FIG. 3) to 1 (Step F204) and asserts interruption signal INT (Step F205). The interruption signal is negated (Step F110) when host 140 reads the status register (Step H206). Because host 140 confirms DREQ=1, host 140 writes the sector data (Step H207). When flash memory 100 writes the sector data for the number of bytes shown in DATAUNIT of the control register, flash memory 100 clears DREQ to 0 (Step F207) and carries out internal processing to write into flash memory cell array 108 (FIG. 1)(Step F208).

If any error occurs in this step (i.e. in the case of “Yes” in Step F209), the flash memory carries out processing for dealing errors. That is, flash memory 100 sets the error flag of status register 103-3 (FIG. 3) (Step F214), clears BUSY to 0 (Step F215), and asserts interruption signal INT (Step F216). The interruption signal INT is negated (Step F217) when host 140 reads the status register (Step H211).

If any error does not occur (i.e. in the case of “No” in Step F209), process is branched (Step F210) according to whether the sector is final one, which is calculated by the sector number to be transferred and set to the SC register or not (Step F210). If the sector is not the final one, the process is carried out again from Step F203. Since host 140 has not finished transfer of the last sector, processing of host 140 also returns from Step H208 to Step H204 or H205.

If flash memory 100 has finished writing data up to the last sector in Step F210, flash memory 100 clears BUSY to zero (Step F215), and asserts interruption signal INT (Step F216). The interruption signal is negated (Step F217) when host 140 reads status register 103-3 (Step H211). Since transferring data of sectors up to the final is finished, host 140 waits the interruption of BUSY=0. Note that host 140 may confirm changes of the status by polling status (Step H209) or waits for the interruption signal from flash memory 100 (Step H210). Thereafter, host 140 confirms the status (Step H211) and ends the processing.

In the present embodiment, interruption signal is described to be constantly enabled. However, as described in FIGS. 6 and 7, host 140 may not use the interruption signal. When host 140 does not use the interruption signal, for example, a flag is set in the control register and valid/invalid of the interruption signal may be changed over in order to disable the interruption signal.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A nonvolatile semiconductor storage device comprising:
a memory cell array of nonvolatile type with block units including a plurality of sectors, each of the plurality of sectors storing user data by being specified each address;
a command register which sets a command to specify type of access operation to the memory cell array;
an address register which sets the each address to be accessed;
a count register which sets a number of the plurality of sectors to be accessed;
a status register which holds status indicating whether processing according to the command set to the command register is carried out or not; and
a sequencer being activated in response to setting of the command to the command register, said sequencer judging whether the type of the access operation is carried out or not based on the command set to the command register and the status held in the status register, and in the case the type of the access operation is carried out, said sequencer accessing to the memory cell array based on the each address set to the address register and the number of the sectors set to the count register.

2. The nonvolatile semiconductor storage device according to claim 1 further comprising:
an error correcting circuit which generates check data to correct errors generated in the user data; and
a buffer which stores the user data in units of the plurality of sectors subject to the access operation to the memory cell array and which stores the check data generated by the error correcting circuit,
wherein, in the case the access operation is data writing, the sequencer writes into the memory cell array the user data subject to the access operation stored in the buffer and the check data generated in the error correcting circuit.

3. The nonvolatile semiconductor storage device according to claim 1 further comprising:
an error correcting circuit which generates check data to correct errors generated in the user data; and
a buffer which stores the user data in units of the plurality of sectors subject to the access operation to the memory cell array and which stores the check data generated by the error correcting circuit,
wherein, in the case the access operation is data reading, the error correcting circuit detects to correct the errors based on the user data read and the check data generated in advance and stored in the memory cell array.

4. The nonvolatile semiconductor storage device according to claim 3, wherein each of the plurality of sectors comprises a user data area used to store the user data and the check data, and a control data area used to store management data to manage the each of the plurality of sectors, and wherein the control data area is used to store free data whose errors are uncorrected by the error correcting circuit, and to store the check data of a first management data whose errors are corrected and a second management data generated by the error correcting circuit.

5. The nonvolatile semiconductor storage device according to claim 4 further comprising a control register which specifies an area subject to the access operation between the user data area and the control data area,
wherein the sequencer specifies the area of a corresponding sector to be accessed based on the control register.
